(19) United States
(12) Patent Application Publication
(10) Pub. No.: US 2012/0149488 A1
(43) Pub. Date: Jun. 14, 2012

(54) GOLF CLUB HOSEL

(76) Inventor: Jason Swist, Edmonton (CA)

(21) Appl. No.: 13/245,902

(22) Filed: Sep. 27, 2011

Related U.S. Application Data
(60) Provisional application No. 61/420,819, filed on Dec. 8, 2010.
(60) Provisional application No. 61/421,665, filed on Dec. 10, 2010.

(51) Int. Cl. A63B 53/02; B23P 11/00

(52) U.S. Cl. 473/314; 29/428

(57) ABSTRACT

Golf is a massive industry as well as sport globally with golfers investing in continuous evolutions and modifications to golf clubs with sensitivity to weight of a few grams, offset in angle of a degree, “feel” etc. Prior art designs focused to the golf club head, grip, and in a few instances the shaft. However, considerations of accurate alignment between the elements during initial assembly/replacement are not addressed. It is, therefore, desirable to provide a means of assembling a golf club shaft that provides for an accurate alignment between the multiple elements such that alignment between them is established, can be maintained with replacements, and also allows for meaningful adjustments in the grip and head to be achieved as multiple other factors do not confound the desired interpretation of the impact of an adjustment. Accordingly the invention provides for such alignment between multiple elements of a golf club.

### CROSS-REFERENCE TO RELATED APPLICATIONS

This patent application claims the benefit of U.S. Provisional Patent Application 61/420,819 filed Dec. 8, 2010 entitled “Golf Club Hosel” and U.S. Provisional Patent Application 61/421,665 filed Dec. 10, 2010 entitled “Golf Club Shaft.”

### FIELD OF THE INVENTION

This invention relates to golf clubs and more specifically to golf club hosels.

### BACKGROUND OF THE INVENTION

Golf is a popular game not only in the US but also many parts of the world such as Korea, Japan, India, China, Germany, UK and South Africa. Within the last 5 years, the golf industry has seen a significant growth of 5-15% annually at various regions of the world. According to a recent market study “Opportunities in the Global Golf Club Market 2004-2009” published by E-Composites, Inc., the golf club market in India and China will continue to see a growth rate of over 25% annually for the period 2010-2014. The growing popularity of the game and the general affluence of golfers ensure a substantial market, which in 2010 was estimated US $3.9 billion.

The market for manufacturers of golf clubs/golf shafts is crowded with small to large corporations such as Callaway, Taylormade, Acushnet, Ping Golf and Wilson. There are more than 100 manufacturers of golf clubs around the world and about 50 of these golf clubs/shafts manufacturers are in the USA. Suppliers of golf clubs/shafts are mostly based in the US, China, Taiwan, Korea, Japan, UK, and Germany.

Considering Callaway, one of the industry leaders, then in 2008 sales were divided between woods (24%), irons (27.6%), putters (9.1%), balls (20%), and other accessories (19.3%). With annual revenues of US$1,100 million in 2008 and US$950 million in 2009 woods, irons, and putters together accounted for approximately 60% of their revenue, US$1,230 million for the two years.

Over the years golf club manufacturers have released hundreds of new models featuring variations in the design of many elements of the golf clubs including hosel profile, heel, top line, toe, face, back, back cavity, sole, weighting for the head alone together with introducing steel variations, titanium and carbon fiber materials for the shafts, and weight, geometry, and polymeric materials for the grip that slides onto the upper portion of the shaft. Despite the massive research and development efforts and brand profiles built upon world renowned figures over the past decades such as Tiger Woods, Jack Nicklaus, Greg Norman, Seve Ballesteros, and Fred Couples the fundamental assembly of golf clubs has not changed for a century since the Thomas Horsburgh experimented with steel shafts in the late 1890s.

Essentially a circular shaft has inserted onto one end a grip with a circular inner recess and onto the other end the head with its hosel and circular recess accepting the lower circular end of the shaft. At the same time the golf club industry has amateur and professional golfers spending hundreds of hours practicing and spending $100s on golf clubs that vary in the angle of the face by a matter of a few degrees. If the clubhead is “square,” the clubface will be directly facing the target on “address”, if it is “closed,” it will be aligned to the left of the target, and if it is “open,” it will be aligned to the right of the target, It is not unusual for game-improvement clubs (those marketed to higher handicappers and accordingly the significant majority of amateur golfers), particularly drivers, to be marketed as having face angles varying by several degrees as a way to help the golfer fight a sliced drive.

Yet the golfer will then replace the grip either to a design they prefer or to replace a worn grip wherein any notion of alignment between the grip and the club head face is lost, Likewise they will perhaps damage the head and replace it, again destroying any notion of alignment between the grip, shaft and head of the club having spent perhaps hundreds of hours practicing, invested in professional coaching, and investments in the latest and supposedly greatest clubs from a particular manufacturer, typically selected from one of the leading 5 brands. Additionally with modern composites golf club manufacturers can adjust the properties of the golf club shaft parallel and perpendicular to the swing direction wherein misalignments rather than improving the player's performance may negate the performance improvement or even degrade their performance.

Replacement of a golf club head or shaft typically involves the following steps:

Step 1—Removing the Old Shaft: The old shaft—or whatever is left of it—must be removed from the head. To do this enough heat must be applied to the club head to break down the epoxy bond between the shaft and the head;

Step 2—Cleaning Out the Hosel: Once the shaft is removed, the epoxy residue that is left in the hosel must be cleaned out which is typically through combination of solvents for the epoxy and a file;

Step 3—Preparing Shaft for Installation: First, the manufacturer's recommended tip trimming must be followed, and then the depth of the hosel measured and marked on the shaft. With graphite care should be taken not to splinter it whilst cutting, and with a steel shaft the tip must be abrade to remove the plating.

Step 4—Installing the Shaft: Now the epoxy is mixed, applied to the inside of the hosel and prepared shaft inserted. Then most instructions will say something along the lines of “holding the head in your hand, tap the end of the shaft on the floor until the shaft is seated at the bottom of the hosel.” Now wait for the epoxy to cure.

Step 5—Trimming and Adding Grip: With replacing the shaft one decides how long the finished club is to be, cuts the shaft and installs the grip.

Step 6: Installing the Grip: First double-sided grip tape is applied the length of the grip, wrapping around the shaft. Then grip solvent is poured into the grip and along the entire length of the new grip tape before the grip is slid onto the shaft. Next the user is typically told to set the club in its normal playing position and check that the new grip is on straight. If adjustments need to be made they must be done quickly to twist the grip to achieve the desired alignment before the epoxy cures too far.

During any of these steps a misalignment may occur, and generally will as tooling is typically not designed to address this aspect. As is evident from the prior art, see for example FIGS. 1 to 3, circular geometry golf club shafts, hosels, grips etc dominate the commercial market today and research/development of the manufacturers globally. However, over the years variations have been taught. For example J. Bamber in U.S. Design Pat. Nos. 594,075 and 556,281, both entitled “Golf Club Shaft”, discloses shafts that are triangular in cross-section over the length of the shaft but transition to circular profile for the ends to adapt to the head hosel and grip. Likewise in U.S. Pat. No. 6,561,922 entitled “Golf Club Shaft” Bamber discloses a club shaft that is elliptical in cross-section along its length but that terminates again in a circular cross-section at either end for mating to circular hosel and grip elements. U.S. Pat. No. 5,540,435 by J. Kawasaki teaches to a circular cross-section shaft that contains a tapered element that engages a tapered inner surface of the shaft such that when pulled by action of a threaded element the shaft is mounted to a club with the tapered element and tapered inner surface in interference fit.

J. Cornish in U.S. Pat. No. 5,354,056 teaches to a circular shaft with circular ends with a spiral outer element and C-S You in U.S. Pat. No. 5,976,032 teaches to reinforcing ribs along the length of the otherwise circular cross-section shaft. J. Farina in U.S. Pat. No. 4,537,403 teaches a single piece-part iron with a rectangular cross-section on the shaft. Farina's one piece part design being incompatible with other clubs as well as composite, titanium, and graphite based shafts that form the materials of choice today. R. Perry in U.S. Pat. No. 6,863,618 teaches a club shaft comprising a flat portion along part of its length but is silent to the construction of the hosel and grip and any means of attaching one to the other.

Accordingly within the prior art design effort has focused to the golf club head, grip, and in a few instances, as outlined above, the shaft. However, considerations of accurate alignment between the elements during initial assembly/replacement are not addressed. It is, therefore, desirable to provide a means of assembling a golf club that provides for an alignment between the multiple elements such that alignment between them is established, can be maintained with replacements, and also allows for meaningful adjustments in the grip and head to be achieved as multiple other factors do not confound the desired interpretation of the impact of an adjustment. According to embodiments of the invention such an alignment is provided between the multiple elements of a golf club.

### SUMMARY OF THE INVENTION

It is an object of the present invention to obviate or mitigate at least one disadvantage of the prior art.

In accordance with an embodiment of the invention there is provided a method comprising:
providing a first component of a golf club comprising a first body, a strike face, and a first recess comprising at least a first wall and a second wall, the first wall having a predetermined geometry and a first predetermined orientation to the strike face;
providing a second component of the golf club comprising a shaft of length substantially larger than its lateral dimensions, of predetermined cross section, and terminating at one end with a first member, the first member comprising at least a first outer surface and a second outer surface, the first outer surface have a geometry substantially that of the predetermined geometry of the first wall;
engaging the first and second components by inserting the first member into the first recess such that the first wall and first outer surface are aligned.

In accordance with another embodiment of the invention there is provided a device comprising a first body, a first outer surface, and a first member comprising at least a first wall and a second wall, the first wall having a predetermined geometry and a predetermined orientation to a predetermined portion of the first outer surface.

In accordance with another embodiment of the invention there is provided a device comprising a first body of length substantially greater than its width or thickness and having a first predetermined cross section, and a member disposed at a first distal end of the first body having a second cross section comprising at least a first wall and a second wall; wherein mating the member with a corresponding recess in another object results in a predetermined relationship between the first wall and an aspect of the other object.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts typical golf club heads and hosels according to the prior art;

FIG. 2 depicts a typical golf club shafts according to the prior art and composite shaft according to U.S. Pat. No. 6,805,642;

FIG. 3 depicts typical golf grips according to the prior art;

FIG. 4A depicts an embodiment of the invention wherein a golf club head and shaft are aligned through their mating interfaces;

FIG. 4B depicts an embodiment of the invention wherein a golf club shaft and grip are aligned through their mating interfaces;

FIG. 5 depicts an embodiment of the invention wherein a golf club face angle is adjusted with replacement of the shaft in conjunction with a golf club head of a standard external geometry;

FIG. 6 depicts an embodiment of the invention wherein a golf club face angle is adjusted with a variation in the golf club head with respect to a golf club shaft of standard external geometry;

FIG. 7 depicts an embodiment of the invention wherein a golf club grip angle is adjusted with replacement of the shaft in conjunction with a grip of a standard external geometry;

FIG. 8 depicts an embodiment of the invention wherein a golf club grip angle is adjusted with a variation in the golf club grip with respect to a golf club shaft of standard external geometry;

FIG. 9 depicts an embodiment of the invention wherein golf club loft angle is adjusted with replacement of the golf club head with a golf club shaft of a standard external geometry;

FIGS. 10A and 10B depict variations of the geometry between the mating portions of the hosel on a golf club and the shaft according to embodiments of the invention;

FIG. 11 depicts an alternative assembly method for a golf club and shaft according to an embodiment of the invention; and

FIG. 12 depicts an alternative coupling method according to an embodiment of the invention.

### DETAILED DESCRIPTION

The present invention is directed to golf clubs and more particularly to golf club hosels that in combination with aligned golf club shafts provided improved alignment of the assembled golf club.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

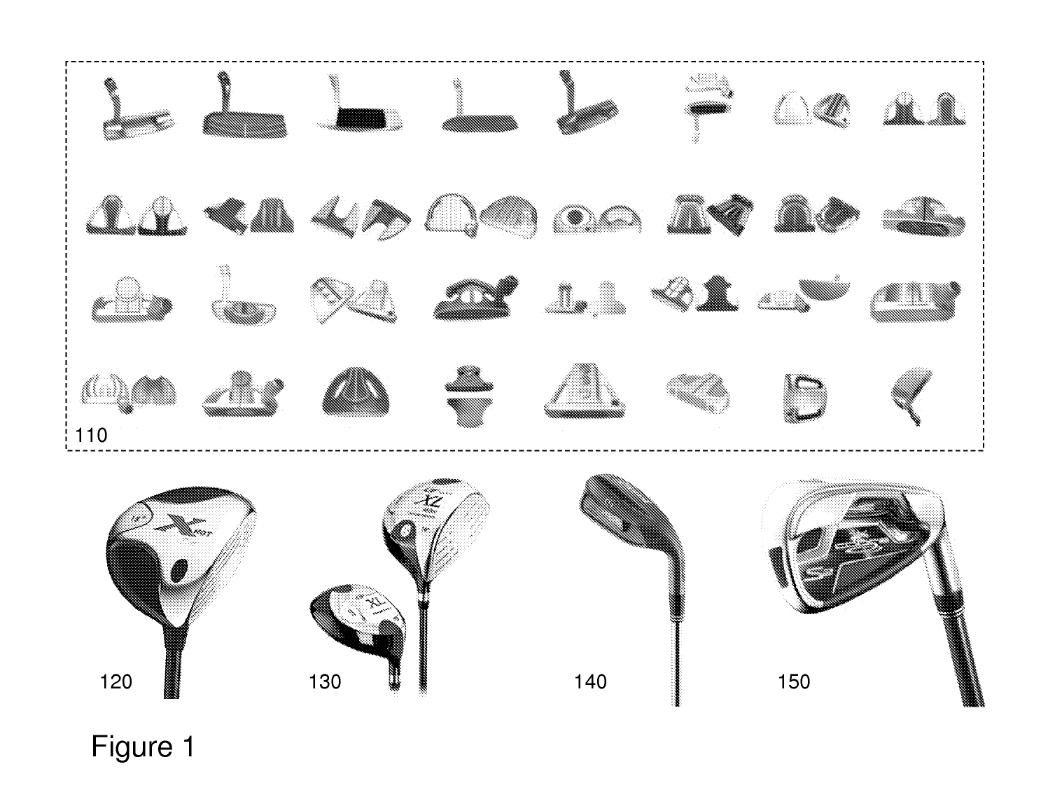

Referring to FIG. 1 there are depicted typical golf club heads and hosels according to the prior art. As is evident from putter array 110 there are a wide variety of designs available even for one specific club, the putter. Shown are 32 different designs that all feature a circular mating interface between the hosel and shaft. Also shown are first driver 120, being a Callaway X-Hot Fairway, second driver 120, being a Top Flite XL, niblick 140, being a Cleveland Golf “The Niblick”, and first iron 150, being a Cobra S2 iron. As is evident all of these have hosels that accept circular golf club shafts.

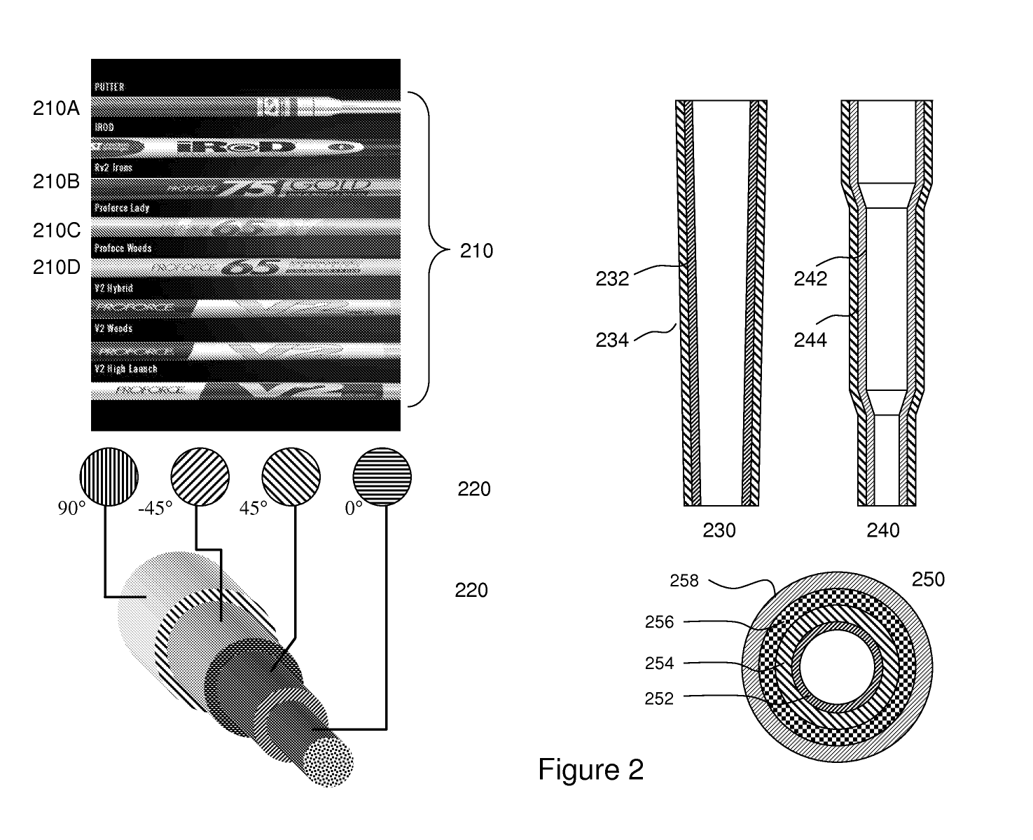

Amongst the technologies for golf club shafts that dominate today are stainless steel, titanium, graphite, and composites. Referring to FIG. 2 there are depicted typical golf club shafts of graphite from one manufacturer UST Mamiya wherein 8 different shafts are presented. These include first to fourth shafts 210A through 210D which are targeted to putters, irons, women, and woods respectively. Graphite schematic 220 shows the construction for a Tour AD Deep Impact shaft manufactured by Graphite Design. As shown the shaft comprises four layers of graphite fibers that are wrapped around a former, having orientations relative to the axis of the shaft that are at 0°, +45°, −45°, and 90° respectively. Referring to first cross-section 230 and second cross-section 240 these are shown each comprising four layers after the prior art of J. Meyer in U.S. Pat. No. 6,805,642 entitled “Hybrid Golf Club Shaft. First cross-section 230 comprises uniform tubular cover layer 232 and tubular core layer 234 whilst second cross-section 240 comprising shaped tubular cover layer 232 and shaped tubular core layer 244.

Meyer teaches that the uniform tubular cover layer 232 and shaped tubular core layer 242 are continuous layers formed from at least one isotropic material having a Young's modulus greater than about 5 Mpsi, preferably greater than about 10 Mpsi. The isotropic material may be a metallic material such as metal matrix composites, metals, or alloys thereof including one or more combinations of metallic constituents. Among the numerous metals that are suitable are ferrous metals such as titanium, steel, stainless steel, aluminum and tungsten are particularly useful. Additionally, certain nonferrous metals including nickel, copper, zinc, brass, bronze, magnesium, tin, gold and silver may be employed generally as alloying agents. Metal matrix composites that are quasi-isotropic may also be desirable for use. The uniform tubular core layer 234 and shaped tubular core layer 244 are taught as being formed from a non-isotropic (i.e. either anisotropic or quasi-isotropic) materials that may be in the form of particles, flakes, whiskers, continuous or discontinuous fibers, filaments, ribbons, sheets, and the like or mixtures thereof. Suitable reinforcement material include carbon fibers, graphite fibers, glass fibers, quartz fibers, boron fibers, ceramic fibers or whiskers such as alumina and silica, metal-coated fibers, ceramic-coated fibers, diamond-coated fibers, carbon nanotubes, aramid fibers such as Kevlar®, poly-pphenylenebenzobisoxazole (“PEO”) fibers such as Zylon®, metal fibers, polythenes, polyacrylates, liquid crystalline polymers, and aromatic polyesters such as Vectran®.

These fibers may be coated with a metal such as titanium, nickel, copper, cobalt, gold, silver, lead, etc. The reinforcement material is impregnated within thermosetting or thermoplastic resins, serving as the matrix binder and providing vibration damping effect to the shaft. Suitable resins include epoxy; polyester; polystyrene; polyurethane; polyurea; polycarbonate; polyamide; polyimide; polyethylene; polypropylene; polyvinyl halide; nylon, liquid crystal polymer, and the like or mixtures thereof. Additionally these resins may further include modifying agents such as hardeners, catalysts, fillers, crosslinkers, etc. Meyer only teaches to shafts that are circular in keeping with the dominant commercial products and majority of the prior art. However, as Applicant there is no limitation to the cross-section when the isotropic material, forming the uniform tubular cover layer 232 and shaped tubular core layer 242, and non-isotropic material, forming the uniform tubular core layer 234 and shaped tubular core layer 244, could be cast, moulded etc with ease to other geometries.

Referring to cross-section 250 an alternate design according to Meyer is shown wherein a reinforcing layer 252, formed from an isotropic or quasi-isotropic material is disposed on the inner surface of core layer 254. This configuration in combination with intermediate layer 256 and outer layer 258 form classic strained layer vibration damping systems that effectively dissipate the mechanical energy in the shaft resulting from striking the golf ball. The reinforcing layer 252 may be continuous or discontinuous, porous or nonporous, similar in construction and/or material composition to cover layer 258 or intermediate layer 256. Alternatively, reinforcing layer 252 may be one or more discrete elements placed at predetermined locations on the shaft to achieve specific objectives, such as weight adjustment, structural reinforcement, stiffness modification, or kick point adjustment, among others.

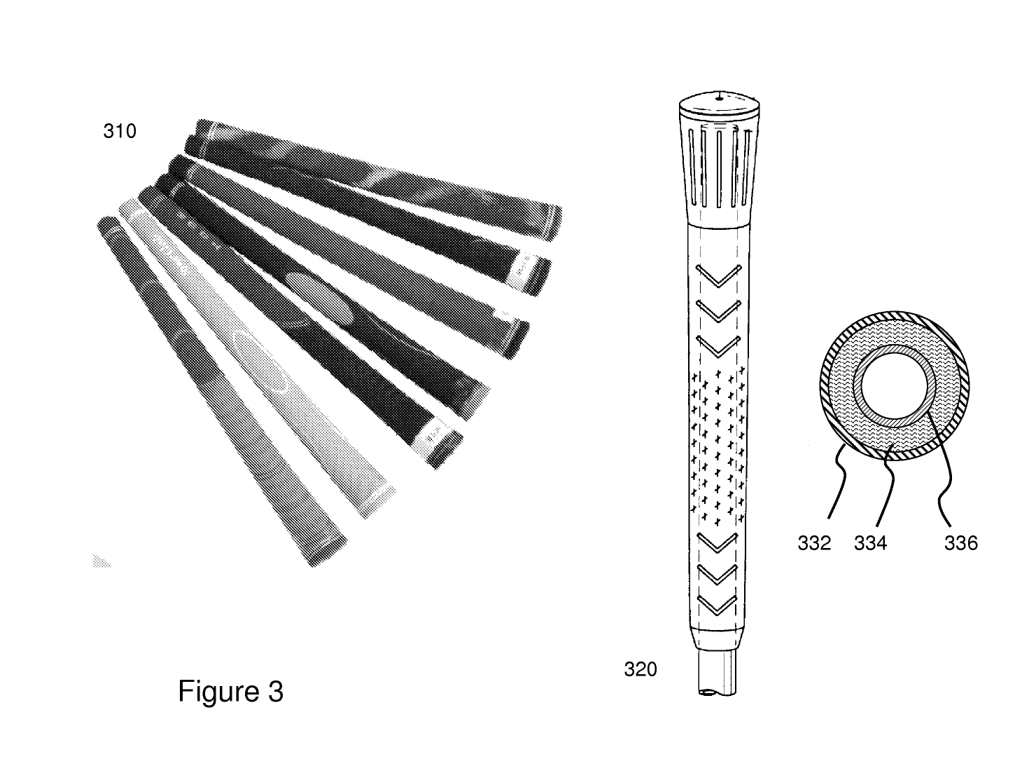

Now referring to FIG. 3 there are shown golf grips 310 in a variety of designs. Whilst golf clubs as shown from FIG. 1 are offered in a large variety of designs by multiple manufacturers the range of grips is even larger as they include not only material and structural design variations but also cosmetic factors of colour, design, etc alongside size to account for the variations in a golfer's hands. Referring to grip 320 there is shown a golf club grip according to the prior art of F. Manual et al in U.S. Pat. No. 6,656,057 entitled “Golf Club Grip.” As such the grip 320 comprises a tubular foam body 334 that is sleeved around the golf club shaft 336 and has an anti-slip skin 332 bonded or laminated integrally to and covering the tubular foam body 334. The grip 320 is tapered and has a substantially bulbous shape, an open end to allow it to be slipped over the golf club shaft 336 and a closed end covering the butt end of the golf club shaft 336, typically with a vent hole. As the grip of the club is an extremely important part of the golfers' ability to achieve the desired stroke designs of the grip 320 vary with differing suitability to individuals. In other instances the grip 320 is moulded to include guides for the golfers' fingers, thumbs and may be moulded to their hands. In such instances the orientation of the grip 320 to the golf club shaft is extremely important as that will then define the orientation of the golfers' hands to the face of the club. This is even more evident when one considers that the face angle of an offset driver such as the M80 SuperSpeed Fairway Woods is only 2°.

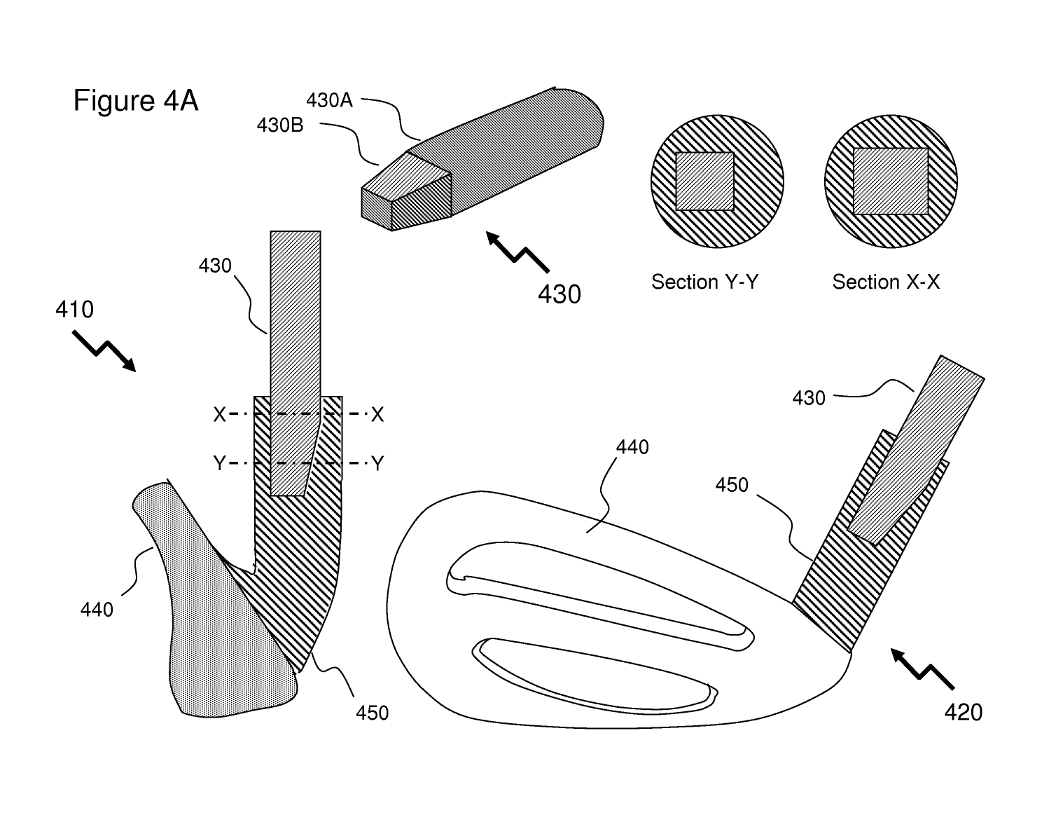

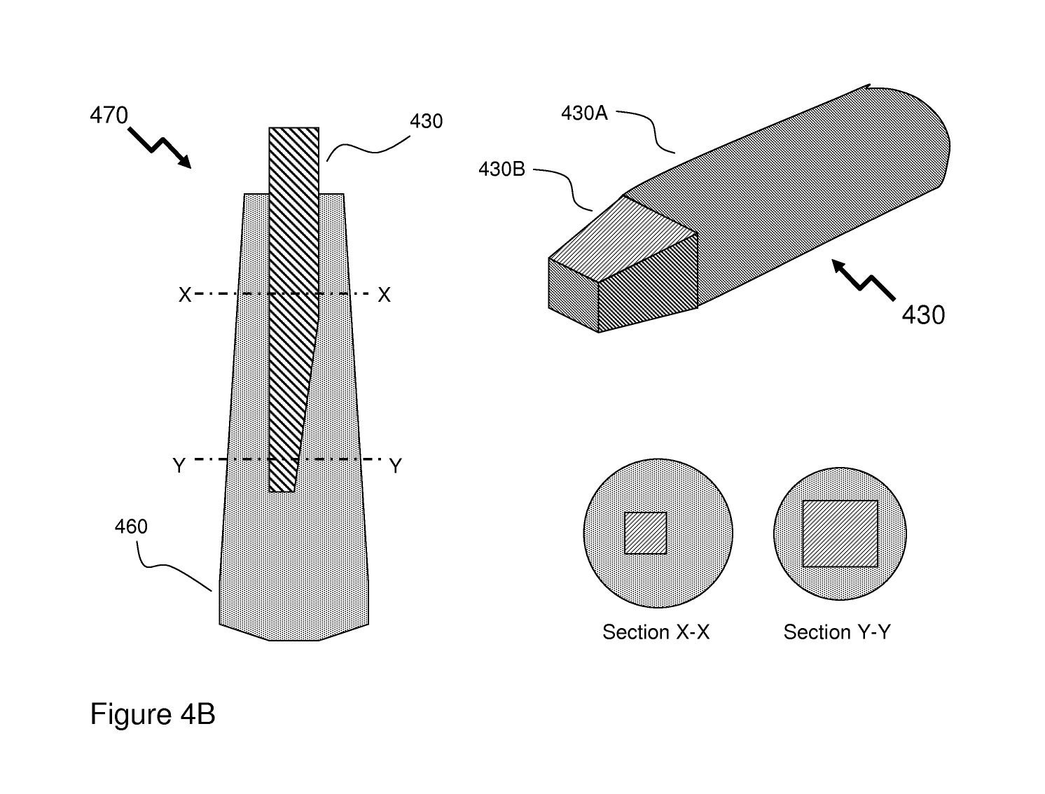

Now referring to FIG. 4A there is depicted a golf club assembly in side section view 410 and front section view 420 according to an embodiment of the invention wherein a golf club hosel 450 and shaft 430 are aligned through their mating interfaces, and the golf club hosel 450 is connected to the club face 440. As is evident the shaft 430 is comprised a body 430A of circular geometry 430A and taper 430B of variable quadrilateral cross-section. As shown the taper 430B fits within the golf club hosel 450 which having a corresponding recess of variable quadrilateral cross-section will receive the taper 430B in only one orientation. Also shown are first and second cross-sections X-X and Y-Y through the side section view 410 showing the engagement of the taper 430B and golf club hosel 450.

Referring to FIG. 4B there is depicted a golf club assembly 470 in cross-section according to an embodiment of the invention wherein a golf club shaft 430 and grip 460 are aligned through their mating interfaces. The shaft 430 is comprised a body 430A of circular geometry 430A and taper 430B of variable quadrilateral cross-section wherein the shaft 430 when inserted into the recess within the grip 460 aligns in a predetermined manner the shaft 430 and grip 460. Also shown are first and second cross-sections X-X and Y-Y through the golf club assembly 470.

It would be apparent to one skilled in the art that other combinations of structures on the golf club hosel, golf club shaft ends, and golf club grip may be employed to achieve the desired predetermined angular orientation between the golf club hosel and golf club shaft and/or golf club shaft and golf club grip. Optionally, such structures may allow only one assembly orientation or they may allow multiple orientations but these are at predetermined angles between an axis of the golf club hosel and/or golf club grip and an axis or axes of the golf club shaft.

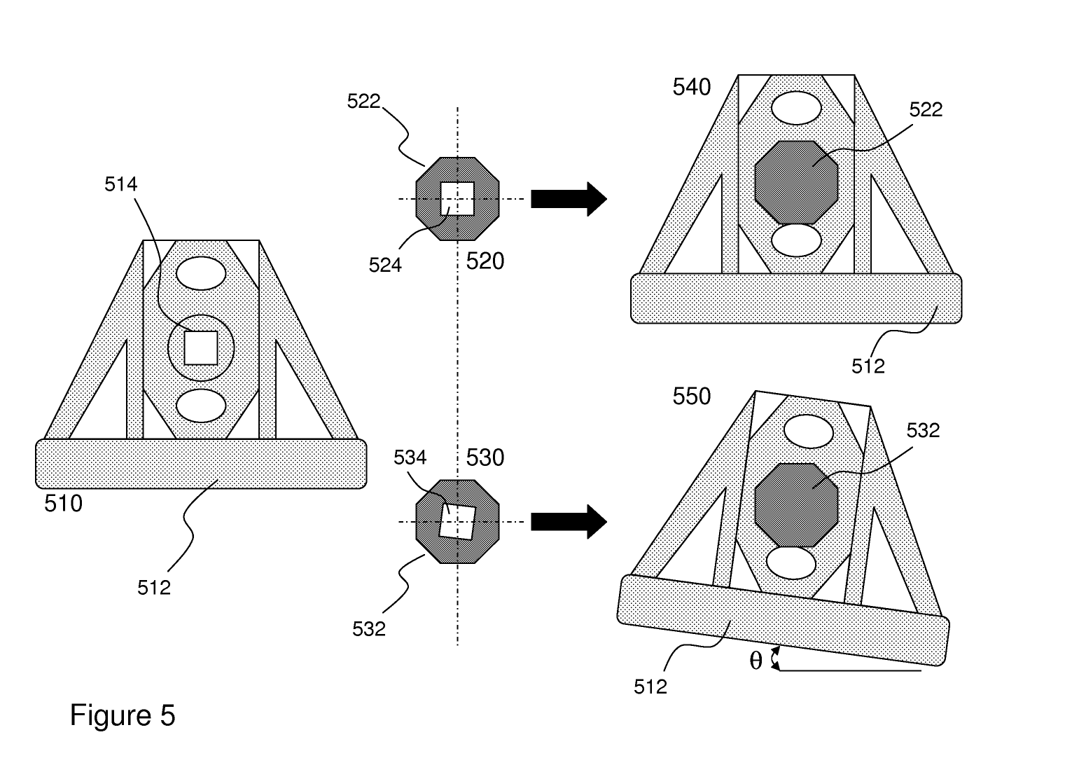

Referring to FIG. 5 there is depicted an embodiment of the invention wherein a golf club face angle is adjusted with replacement of the shaft in conjunction with a golf club head 510 of a standard external geometry 512 with a hosel recess 514 of square cross-section. First golf club shaft 520 comprises first body 522 of octagonal cross-section (for ease of detecting rotational changes in the depiction of embodiments) and first square end 524. Accordingly when first square end 524 is inserted into the hosel recess 514 the resulting first assembly 540 results wherein the first body 522 and standard external geometry 512 are aligned. Second golf club shaft 530 comprises second body 532 of octagonal cross-section (for ease of detecting rotational changes in the depiction of embodiments) and second square end 524. Accordingly when second square end 524 is inserted into the hosel recess 514 the resulting second assembly 540 results wherein the second body 522 and standard external geometry 512 are now aligned with a predetermined rotational offset, θ.

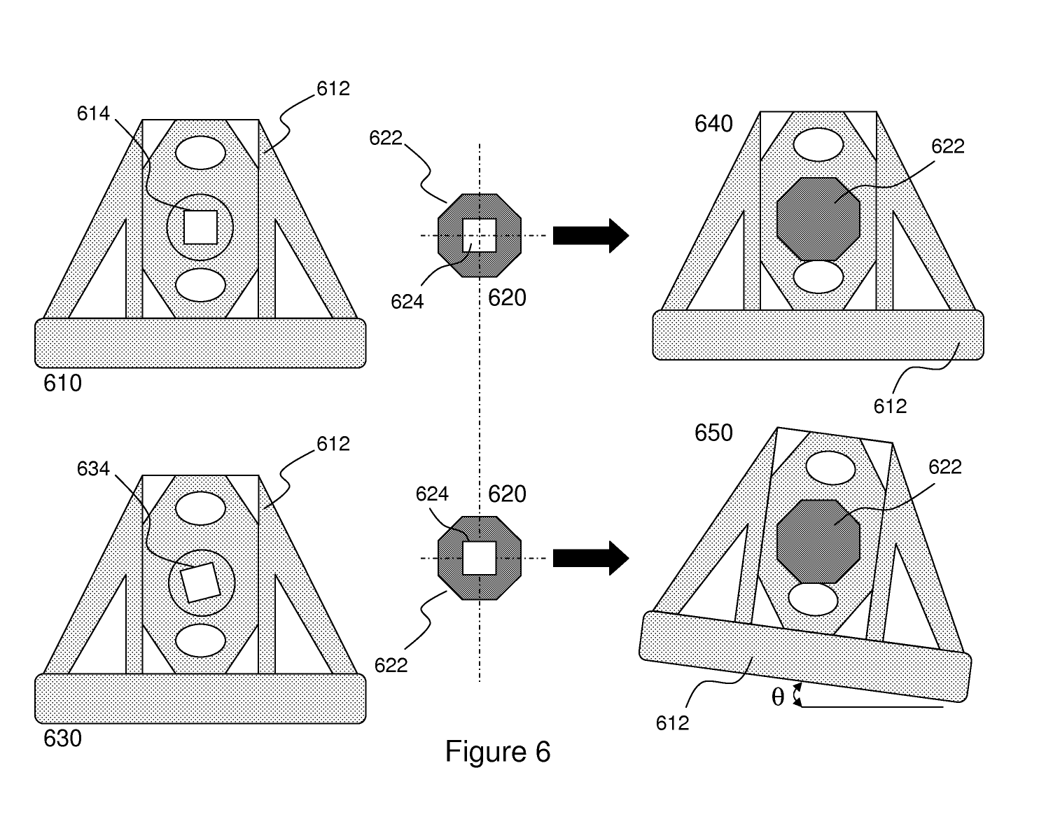

Now referring to FIG. 6 there are depicted embodiments of the invention wherein a golf club face angle is adjusted with a variation in the golf club head with respect to a golf club shaft of standard external geometry. First golf club head 610 of a standard external geometry 612 has a first hosel recess 614 of square cross-section. Golf club shaft 620 comprises first body 622 of octagonal cross-section (for ease of detecting rotational changes in the depiction of embodiments) and square end 624. Accordingly when square end 624 is inserted into the first hosel recess 614 the resulting first assembly 640 results wherein the first body 622 and standard external geometry 612 are aligned. Second golf club head of a standard external geometry 613 has second hosel recess 634 of square geometry but rotated with respect to the standard external geometry 612. Accordingly when square end 624 is inserted into the second hosel recess 634 the resulting second assembly 650 results wherein the body 622 and standard external geometry 612 are now aligned with a predetermined rotational offset, θ.

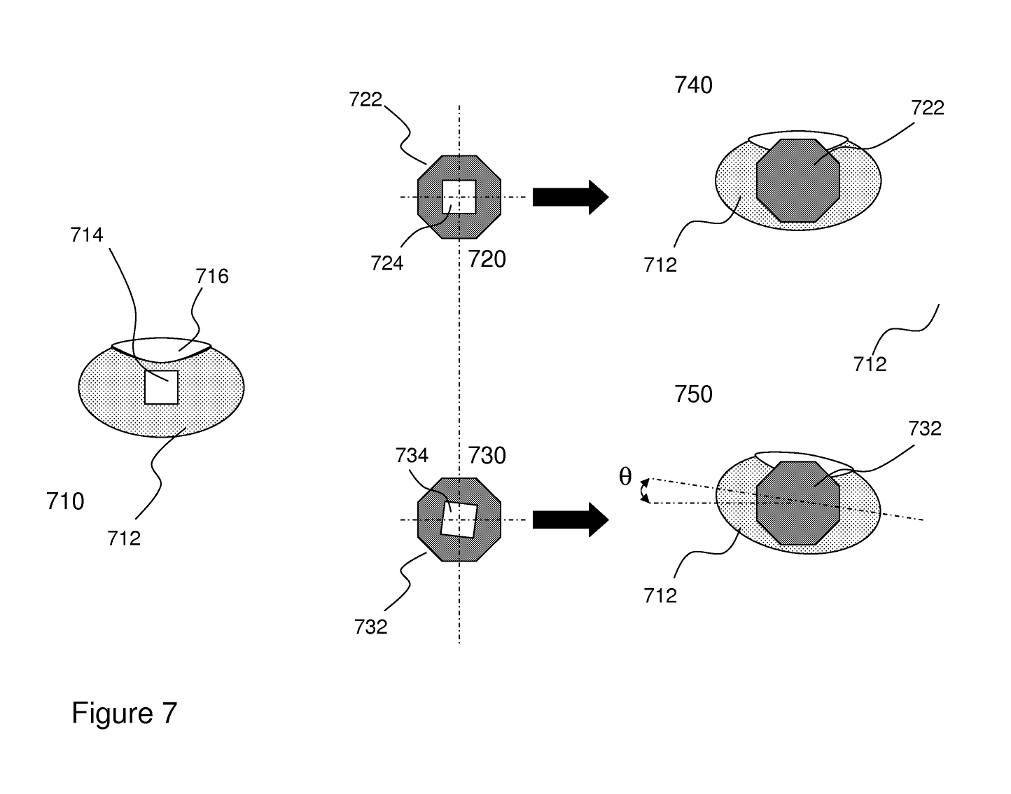

Referring to FIG. 7 there is depicted an embodiment of the invention wherein a golf club grip orientation is adjusted with replacement of the shaft in conjunction with a golf club grip 710 of an elliptical geometry 712 with finger grip 716 and hosel recess 714 of square cross-section. First golf club shaft 720 comprises first body 722 of octagonal cross-section (for ease of detecting rotational changes in the depiction of embodiments) and first square end 724. Accordingly when first square end 724 is inserted into the hosel recess 714 the resulting first assembly 740 results wherein the first body 722 and elliptical geometry 712 are aligned. Second golf club shaft 730 comprises second body 732 of octagonal cross-section (for ease of detecting rotational changes in the depiction of embodiments) and second square end 724. Accordingly when second square end 724 is inserted into the hosel recess 714 the resulting second assembly 750 results wherein the second body 732 and elliptical geometry 712 are now aligned with a predetermined rotational offset, θ.

As depicted in FIG. 7 the golf club grip 710 is depicted as essentially fitting onto the end of the golf club shaft 720 wherein the interface is over the length of the square end of the golf club shaft and hosel recess 714. However, it would be apparent that the hosel recess may be provided at a predetermined point along the length of the grip from the end closest to the club head and the second distal end of the golf club grip with another recess allowing the golf club shaft to fit within such that the grip sits over a predetermined length of the golf club shaft but is rotationally aligned by the engagement of the hosel recess and square end of the shaft.

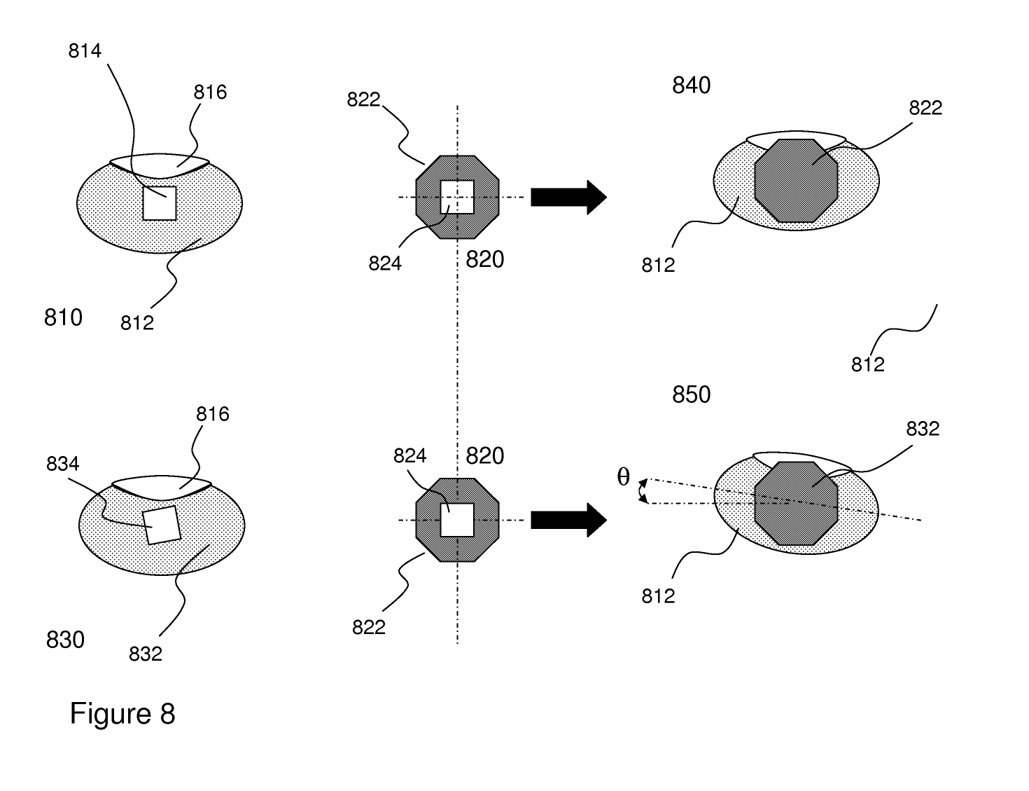

Now referring to FIG. 8 there are depicted embodiments of the invention wherein a golf club grip orientation is adjusted with a variation in the golf club grip with respect to a golf club shaft of standard external geometry. First golf club grip 810 comprises an elliptical geometry 812 with finger grip 814 and first hosel recess 814 of square cross-section. Golf club shaft 820 comprises first body 822 of octagonal cross-section (for ease of detecting rotational changes in the depiction of embodiments) and square end 824. Accordingly when square end 824 is inserted into the first hosel recess 814 the resulting first assembly 840 results wherein the first body 822 and standard external geometry 812 are aligned. Second golf club grip of elliptical geometry 832 has finger grip 816 and second hosel recess 834 of square geometry but rotated with respect to the elliptical geometry 832. Accordingly when square end 824 is inserted into the second hosel recess 834 the resulting second assembly 850 results wherein the body 822 and elliptical geometry 812 are now aligned with a predetermined rotational offset, θ.

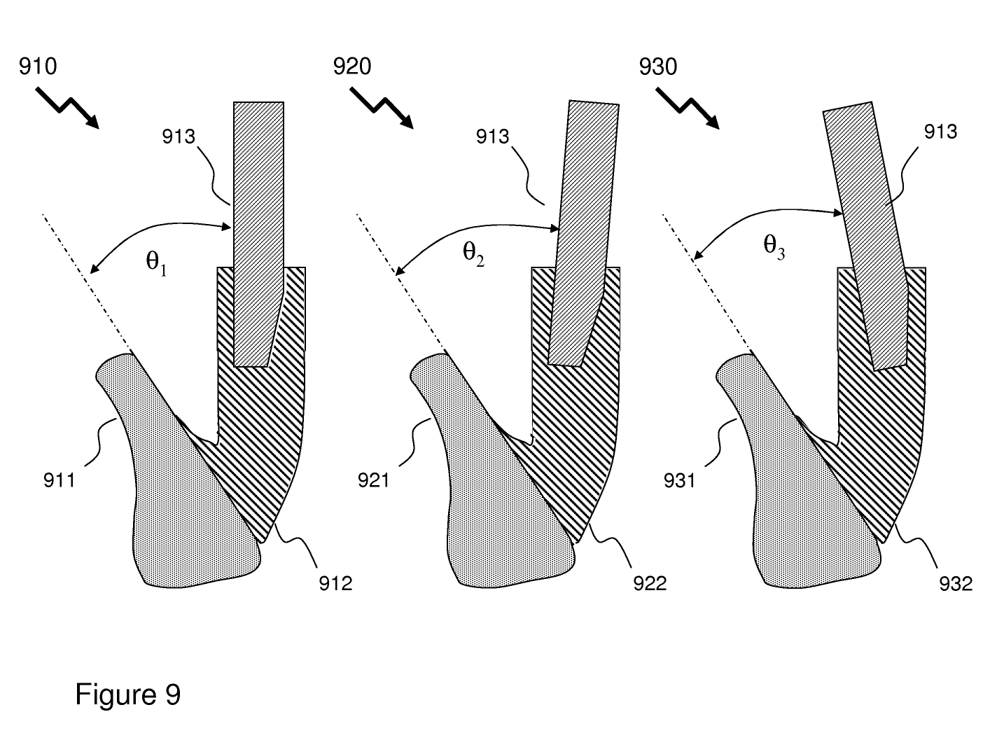

Referring to FIG. 9 there is depicted an embodiment of the invention wherein golf club loft angle is adjusted during replacement of the golf club head using a golf club shaft 913 of a standard external geometry such as described previously in respect of golf club shaft 430 in FIG. 4A with circular main body and taper of variable quadrilateral cross-section. In first cross-section 910 the golf club shaft 913 is inserted to a matching variable quadrilateral cross-section recess within first hosel 912 to which is attached first head 911. As such the face of the head 911 is offset by first angle θ₁ with respect to golf club shaft 913. In second cross-section 920 the golf club shaft 913 is inserted to a matching variable quadrilateral cross-section recess within second hosel 922 to which is attached second head 921. As such the face of the second head 921 is offset by second angle θ₂ with respect to golf club shaft 913. In third cross-section 930 the golf club shaft 913 is inserted to a matching variable quadrilateral cross-section recess within third hosel 922 to which is attached third head 921. As such the face of the third head 921 is offset by third angle θ₃ with respect to golf club shaft 913.

It would be evident to one skilled in the art that the above described embodiments of adjust the loft angle of a golf club face may be implemented with a wide range of varying configurations and structures for the golf club hosel and end of the golf club shaft without departing from the scope of the invention.

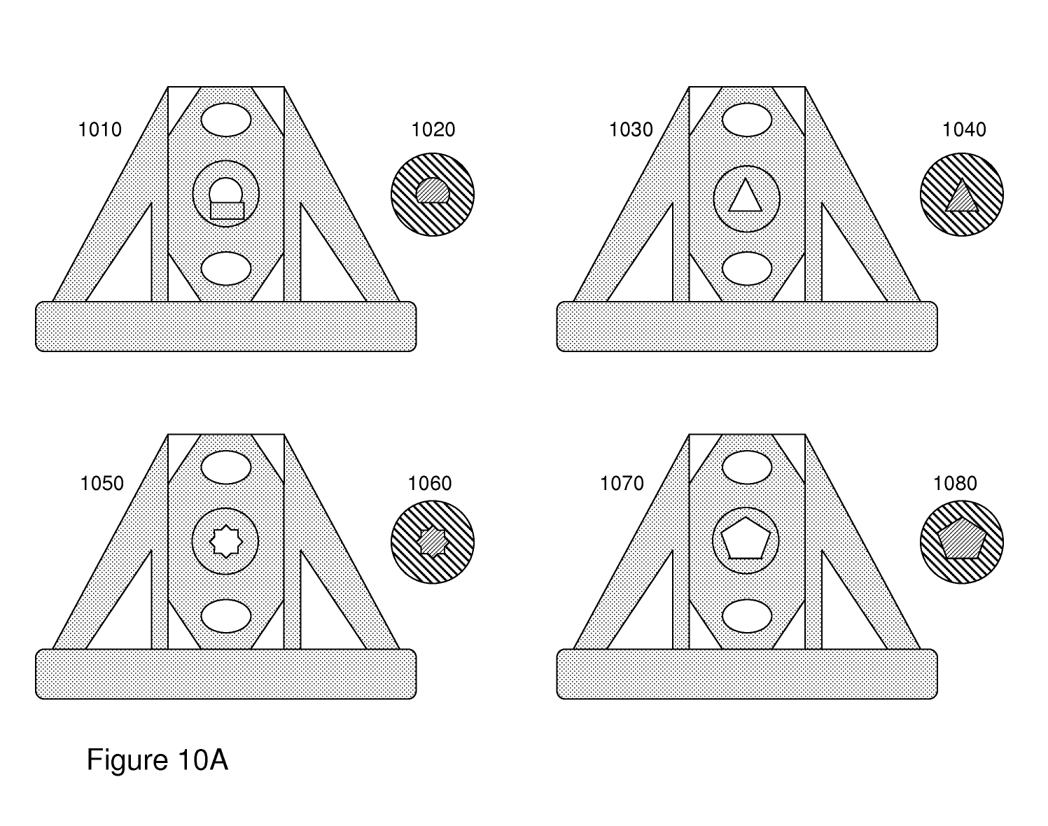

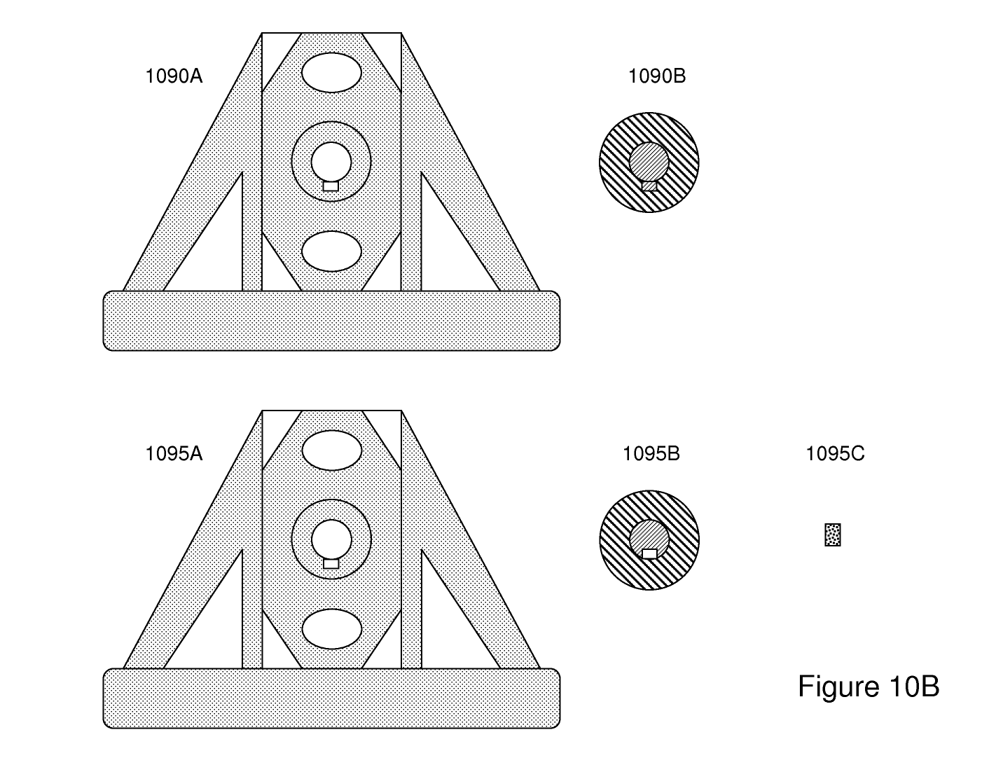

Now referring to FIG. 10A there are depicted variations of the geometry between the mating portions of the hosel on a golf club and the shaft according to embodiments of the invention. First club head 1010 has a truncated circular hosel recess that corresponds to first shaft 1020 with truncated circular element whilst second club head 1030 has a triangular hosel recess that corresponds to second shaft 1020 with triangular element. Third club head 1050 has an octagonal star hosel recess that corresponds to third shaft 1060 with octagonal star element, and fourth club head 1070 has a pentagonal hosel recess that corresponds to first shaft 1020 with pentagonal element. It would be evident to one skilled in the art that each of the combinations in FIG. 10A provides the registered alignment of the end of the golf club shaft to the hosel of the golf club head. It would also be evident that the same alternatives in respect of end of the golf club shaft and the recess may be applied to the golf club grip as well.

Referring to FIG. 10B there are depicted variations of the geometry between the mating portions of the hosel on a golf club and the shaft according to embodiments of the invention. First club head 1090A has a circular hosel recess with a rectangular notch whilst first shaft 1090B that has circular projection with a rectangular projection such that these elements correspond in profiles such that first club head 1090A aligns to first shaft 1090B in predetermined angular relationship. Also depicted are second club head 1095A has a circular hosel recess with a rectangular notch whilst first shaft 1095B that has circular projection with a rectangular notch a well such that these elements correspond in profiles. When the first club head 1095A has first shaft 1095B inserted into the hosel recess then they can be fixed in predetermined angular relationship through the use of tapered pin 1095C. It would be evident that a variety of other mating designs may be employed with or without additional means to fix the parts in alignment.

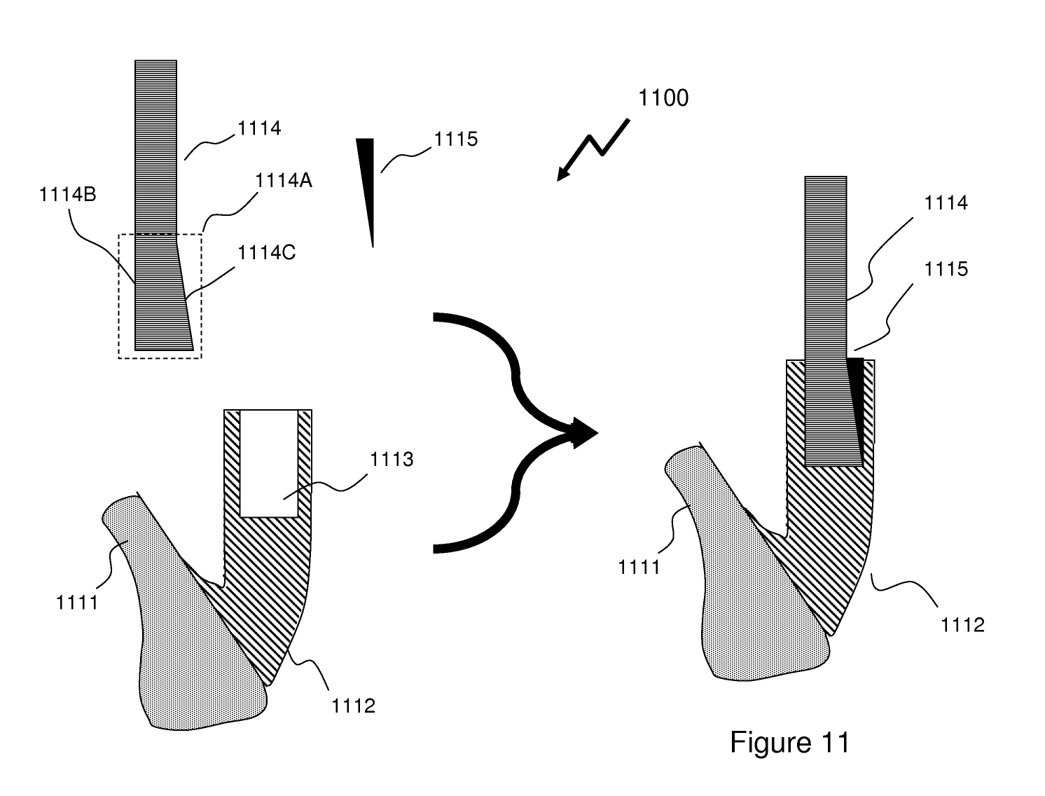

Referring to FIG. 11 there is depicted and alternative assembly method 1100 for a golf club head and shaft according to an embodiment of the invention. As shown the golf club head comprises head 1111, hosel 1112, and hosel recess 1113 whilst the shaft comprises body section 1114 that terminates in end 1114A having first face 1114B and second face 1114C. Also shown is insert 1115 which is tapered in cross-section along its length. Accordingly the end 1114A of the shaft is inserted into the hosel recess 1113 whereupon insert 1115 is inserted thereby wedging the end 1114A into hosel recess 1113.

It would be evident to one skilled in the art that insert 1115 may for example maintain the engagement of end 1114A into hosel recess 1113 through mechanical interference or through it being formed from a material such Indalloy 165 (ASTM 1.5S) or Pb₉₀Sn₁₀ allowing the parts to be soldered in place as an alternative to the conventional epoxy construction. It would also be apparent that the same principle may be employed in attaching the grip and shaft together as well as conventional methods based upon adhesives, tapes, epoxies, resins, etc.

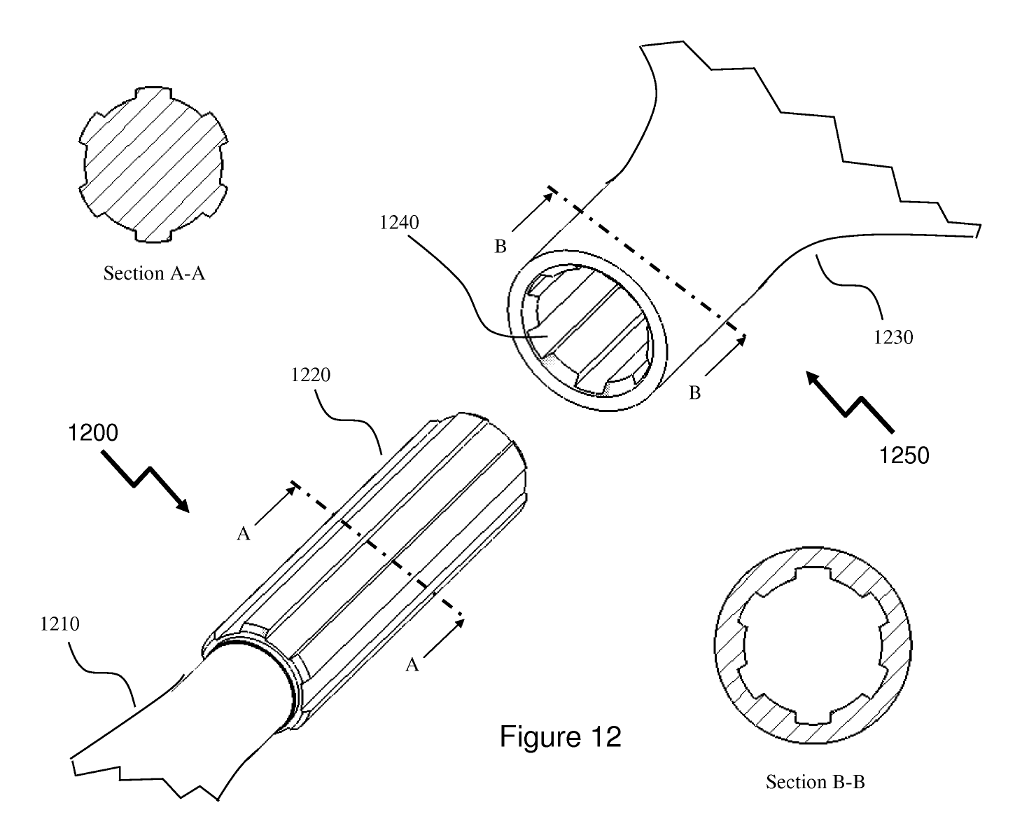

In the embodiments described supra the recess/member have been discussed as being of relatively simple cross sectional design. It would be apparent to one of skill in the art that alternative designs exist that have increased complexity such as the interface shown in FIG. 12 wherein the member 1220 formed at the end of the shaft 1210 of the first element 1200 has a generally circular cross-section with ribs as evident from first cross-section A-A. Similarly, the recess 1230 formed within the hosel 1240 of the second element 1250 has corresponding circular cross section with grooves to match the locations of the ribs as evident from second cross-section B-B.

It would be evident to one skilled in the art that the embodiments described supra in respect of FIGS. 4 through 12 have been discussed in terms of the golf club shaft have projecting members that engage recesses within the golf club grip and hosel of the golf club head. It would be apparent that optionally the recess may in fact be on the golf club shaft such that the projecting member is on either the golf club hosel or golf club grip or both. It would be apparent that the depth/length of the recess/projection may be established in dependence upon whether the elements are golf club head/shaft or shaft/grip for example as well as the accuracy of alignment desired between the elements. It would also be apparent that a variety of attachment means can be employed for the golf club hosel to the golf club shaft and/or golf club shaft to golf club grip including but not limited to solder, resins, epoxies, cyanoacrylate adhesives, mechanical interference fits, bolts and threaded inserts. For example first element 1200 may have a threaded insert in the end of the member 1220 such that a bolt inserted through the base of the golf club shaft into recess 1240 of second element 1250 may be tightened to lock the golf club shaft and golf club head together whilst angular alignment is maintained through the action of the ribs/recesses. Alternatively, a solder or epoxy may be employed.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
providing a first component of a golf club comprising a first body, a strike face, and a first recess comprising at least a first wall and a second wall, the first wall having a predetermined geometry and a first predetermined orientation to the strike face;
providing a second component of the golf club comprising a shaft of length substantially larger than its lateral dimensions, of predetermined cross section, and terminating at one end with a first member, the first member comprising at least a first outer surface and a second outer surface, the first outer surface have a geometry substantially that of the predetermined geometry of the first wall;
engaging the first and second components by inserting the first member into the first recess such that the first wall and first outer surface are aligned.

2. The method of claim 1 wherein,
the first recess forms part of a hosel forming a predetermined portion of the first component.

3. The method of claim 1 wherein,
the engagement of the first and second components results in predetermined angular orientation of the strike face to a longitudinal axis of the second component.

4. The method of claim 1 wherein,
at least one of the first recess in cross section and the predetermined cross section is at least one of a predetermined portion of a regular polygon, semi-circular, elliptical, and truncated circular.

5. The method of claim 1 further comprising,
providing a third component of the golf club comprising a second body and a second recess comprising at least a third wall and a fourth wall, the third wall having a predetermined geometry and a second predetermined orientation relating to an aspect of at least one of the second body of the third component and a user of the golf club;
providing a second member at the other distal end of the second component, the second member comprising at least a third outer surface and a fourth outer surface, the third outer surface have a geometry substantially that of the predetermined geometry of the third wall; and
engaging the second and third components by inserting the second member into the second recess such that the third wall and third outer surface are aligned.

6. The method of claim 5 wherein;
upon assembly of the first, second and third components there is a third predetermined orientation between the strike face of the first member and the aspect of the at least one of the second body and the user of the golf club.

7. The method of claim 6 wherein,
the aspect of the at least one of the second body and the user of the golf club relates to at least one of a finger, a thumb, and a palm of the user of the golf club.

8. The method of claim 5 wherein,
the second recess in cross section is at least one of a predetermined portion of a regular polygon, semi-circular, elliptical, and truncated circular.

9. A device comprising:
a first body;
a first outer surface comprising at least a strike face of a golf club; and
a first member comprising at least a first wall and a second wall, the first wall having a predetermined geometry and a predetermined orientation to the strike face.

10. The device according to claim 9 wherein,
the first body is at least one of a grip for a golf club shaft, a hosel for a golf club head, and a golf club head.

11. The device according to claim 9 wherein,
the first member in cross section is at least one of a predetermined portion of a regular polygon, semi-circular, elliptical, and truncated circular.

12. The device according to claim 9 wherein,
the first member is at least one of a recess and a projection away from the surface of the device.

13. A device comprising:
a first body of length substantially greater than its width or thickness and having a first predetermined cross section; and
a member disposed at a first distal end of the first body having a second cross section comprising at least a first wall and a second wall; wherein
mating the member with a corresponding recess in another object comprising at least a strike face results in a predetermined relationship between the first wall and the strike face of the other object.

14. A device according to claim 13 wherein,
the first body is at least one of a golf club shaft and a grip for a golf club shaft.

15. The device according to claim 13 wherein,
the first member in cross section is at least one of a predetermined portion of a regular polygon, semi-circular, elliptical, and truncated circular.

16. The device according to claim 13 wherein,
the first member is at least one of a recess and a projection away from distal end of the device substantially along a longitudinal axis of the device.
